(19) United States
(12) Patent Application Publication
(10) Pub. No.: US 2026/0092445 A1
(43) Pub. Date: Apr. 2, 2026

(54) Wool Fiber Insulation Blend

(71) Applicant: Jamie C. Conner, Vero Beach, FL (US)

(72) Inventor: Jamie C. Conner, Vero Beach, FL (US)

(21) Appl. No.: 18/899,913

(22) Filed: Sep. 27, 2024

(51) Int. Cl. E04B 1/78; C08L 89/04; E04B 1/74; E04B 1/94

(52) U.S. Cl. CPC E04B 1/78; C08L 89/04; E04B 1/941; C08L 2201/02; C08L 2201/06; C08L 2205/16; E04B 2001/745

(57) ABSTRACT

A wool-based insulation material is disclosed, wherein the majority fiber component is wool, making up over 50% of the total composition. The wool is blended with a proprietary fire-retardant adhesive and a minority component of green fibers (less than 50%), which includes natural fibers such as hemp fibers, soy fibers, and banana fibers. These plant-based fibers contribute to the insulation's sustainability and structural properties. The blend specifically excludes impurities such as hemp hurd, wood chips, and stalk materials. This insulation material combines excellent fire resistance, thermal insulation, and environmental sustainability, with wool serving as the critical component.

### FIELD OF THE INVENTION

The present application relates to wool-based insulation materials, specifically nonwoven blends that incorporate wool as the primary fiber component. These materials are designed for enhanced thermal efficiency, fire resistance, and environmental sustainability. Wool fibers are blended with other natural fibers and proprietary fire-retardant adhesives to produce a superior insulation material. These plant-based fibers contribute to the insulation's sustainability and structural properties. The blend specifically excludes impurities such as hemp hurd, wood chips, and stalk materials. This insulation material combines excellent fire resistance, thermal insulation, and environmental sustainability, with wool serving as the critical component.

### BACKGROUND OF THE INVENTION

Traditional insulation materials, such as fiberglass or cellulose, offer varying degrees of thermal efficiency but often come with environmental drawbacks, such as high energy consumption during production or limited biodegradability. Natural fibers, including wool, provide an eco-friendly alternative due to their renewability, biodegradability, and thermal efficiency properties. Wool is known for its natural fire resistance and thermal insulation properties, making it an excellent choice for eco-conscious insulation solutions.

Wool, when used as the majority fiber component in insulation, can offer better fire resistance and thermal efficiency compared to synthetic or plant-based materials. However, blending wool with other natural fibers like hemp, soy, or banana fibers can enhance the structural and mechanical properties of the insulation material while maintaining its sustainability.

Accordingly, a need exists for a wool-based insulation material that combines excellent thermal efficiency, fire resistance, and environmental sustainability by using wool as the critical component.

### SUMMARY OF THE INVENTION

The present invention discloses a wool-based insulation material, wherein the majority fiber component is wool, constituting more than 50% of the total composition. The wool is blended with a proprietary fire-retardant adhesive and a minority component of green fibers (less than 50%) derived from natural sources, such as hemp fibers, soy fibers, and banana fibers. These plant-based fibers contribute to the insulation's sustainability, mechanical strength, and thermal performance.

The blend specifically excludes impurities such as hemp hurd, wood chips, and stalk materials, ensuring a high-quality composition. The result is a nonwoven insulation material with superior fire resistance, excellent thermal efficiency, and reduced environmental impact, with wool serving as the essential component. The batt is designed to fit wall cavity dimensions of 15.5 inches or 23.5 inches in width, with lengths of 93 inches, and varying depths ranging from 3.5 to 11.5 inches to match standard wall construction.

### DETAILED DESCRIPTION OF THE INVENTION

### Description

### Field of the Invention

The present invention relates to an eco-friendly insulation material primarily composed of wool fibers, incorporating natural, plant-based fibers such as hemp, soy, and banana fibers in a secondary role. The insulation material is bound together with a proprietary adhesive fire retardant, making it suitable for use in a variety of building applications where both fire resistance and environmental sustainability are essential.

### Background of the Invention

Many conventional insulation materials rely on synthetic fibers and polymers, which are not environmentally friendly. There is a growing demand for sustainable alternatives that combine natural fibers with fire-resistant properties. Wool has long been recognized for its insulating properties, but previous inventions have not fully optimized the balance between fire resistance, sustainability, and fiber composition. This invention aims to provide an innovative solution by using wool as the majority component, combined with a proprietary adhesive fire retardant and a minority component of green fibers.

### Summary of the Invention

The insulation material described in this invention is primarily composed of wool fibers, which make up more than 50% of the total material. Wool provides excellent insulation due to its natural fire-resistant properties, moisture regulation, and thermal performance. A proprietary adhesive fire retardant (making up over 20% of the composition) binds the wool and green fibers together, enhancing the material's overall fire resistance. The remaining fiber content, less than 50%, consists of green, plant-based fibers, including but not limited to hemp fibers, soy fibers, and banana fibers. This unique combination of wool, adhesive fire retardant, and green fibers results in an eco-friendly insulation material that is both durable and fire-resistant, with the added benefit of using renewable resources. The invention specifically excludes impurities such as hemp hurd, wood chips, and stalk materials, ensuring a clean and high-performance product.

### Detailed Description of the Invention

The wool-based insulation blend of the invention comprises the following components: Wool Fibers (Over 50%): Wool is the primary component of the blend, selected for its natural insulating properties, flame resistance, and ability to regulate moisture. Wool fibers provide the bulk of the material's structure and contribute significantly to its thermal performance.

Proprietary Adhesive Fire Retardant (Over 20%): A proprietary fire-retardant adhesive is used to bind the wool and green fibers together, offering enhanced fire resistance without compromising the environmental sustainability of the material. The adhesive is designed to be compatible with natural fibers and ensure the integrity of the blend.

Green Fibers (Less than 50%): The remainder of the material consists of green fibers, which enhance the sustainability and strength of the insulation. The green fibers used in the blend include: (Hemp Fibers: Selected for their strength and sustainability, hemp fibers contribute to the structural integrity of the insulation while maintaining an environmentally friendly profile. The fibers are processed to exclude hemp hurd, wood, and stalk materials, which are considered impurities. Banana Fibers: Known for their high tensile strength and biodegradability, banana fibers add strength and flexibility to the blend. Soy Fibers: Soy fibers offer flexibility and durability, further contributing to the performance of the insulation material.)

### Applications

The wool-based fiber insulation material is designed for use in various construction applications, particularly in walls, ceilings, attics, and other spaces where thermal insulation and fire resistance are required. The combination of wool and green fibers offers a sustainable alternative to traditional insulation materials, suitable for both residential and commercial buildings.

### DETAILED DESCRIPTION OF EMBODIMENTS

In a preferred embodiment, the insulation material comprises between 50% and 90% wool fibers, ensuring that wool is the predominant component. The wool provides natural thermal regulation, fire resistance, and moisture-wicking capabilities. The wool fibers are blended with less than 50% of plant-based fibers, such as hemp, soy, or banana fibers. These natural fibers contribute to the material's structural integrity and sustainability.

In another embodiment, the wool and plant fiber blend is combined with a proprietary fire-retardant adhesive that enhances the material's fire resistance without compromising its thermal properties. The fire-retardant adhesive ensures that the insulation meets or exceeds industry standards for fire safety in residential and commercial applications.

In another embodiment, the blend of wool and green fibers excludes impurities such as hemp hurd, wood chips, or other stalk materials to maintain the material's quality and effectiveness as an insulator. This results in a cleaner, more uniform material that performs well in various environmental conditions.

In another embodiment, the wool-based insulation material can be used in various applications, including but not limited to wall insulation, roof insulation, and acoustic panels. The wool component enhances thermal regulation in both hot and cold environments, while the plant fibers improve structural support.

In another embodiment, the insulation material's fire resistance makes it suitable for buildings with strict fire safety requirements, while its sustainability makes it an attractive option for eco-conscious consumers. Additionally, the insulation material is biodegradable, contributing to reduced environmental impact at the end of its life cycle.

The wool-based insulation material of claim 1, wherein the wool fibers have the ability to purify air by absorbing harmful pollutants such as formaldehyde, nitrogen oxide, and sulfur dioxide. The wool fibers trap and lock away these pollutants, contributing to improved indoor air quality, making the material particularly beneficial in environments with limited air exchange.

In another embodiment, the wool-based insulation material of claim 1, wherein the wool fibers contribute to enhanced thermal regulation through moisture absorption. As the wool fibers absorb moisture, an exothermic reaction releases heat, stabilizing the temperature within the insulated space. This moisture control improves the energy efficiency of buildings, reducing the demand on heating and cooling systems, while also creating a more comfortable living environment by managing humidity levels.

In another embodiment, the wool-based insulation material of claim 1, wherein the wool fibers exhibit superior moisture absorbency, capable of absorbing up to 30% of their weight in moisture without feeling wet. This unique hydrophilic property allows the insulation material to regulate indoor humidity levels effectively, preventing condensation, mold growth, and structural damage while maintaining a dry surface.

In another embodiment, wool is well-established as a highly efficient insulator due to its natural fiber structure, which traps air pockets, providing excellent thermal regulation. The decision to make wool the majority component (over 50%) ensures that the material takes full advantage of these natural properties. Wool's intrinsic moisture management also contributes to its superior insulating capacity, as it absorbs water vapor and releases it without compromising thermal efficiency.

In another embodiment, the inclusion of plant-based fibers such as hemp, soy, and banana (each less than 50%) provides structural support and sustainability benefits. These fibers are chosen for their compatibility with wool, as they have similarly beneficial environmental properties and can improve the tensile strength of the composite material without detracting from the thermal efficiency.

In another embodiment, the proprietary fire-retardant adhesive is necessary to enhance the fire resistance of the blend. While wool has natural flame-retardant properties due to its high nitrogen and moisture content, additional fire resistance is desirable for modern building standards. By incorporating a proprietary adhesive, the wool-based insulation achieves a higher level of fire safety while maintaining its structural integrity and thermal performance.

In another embodiment, the decision to exclude impurities like hemp hurd, wood chips, and stalk materials ensures a clean blend, minimizing any impact on thermal efficiency and consistency in performance. Impurities could introduce variability in fiber quality and performance, making the insulation less reliable.

In another embodiment, wool's natural fire resistance is one of its most important features in insulation applications. Wool fibers have a high ignition temperature (about 570-600° C.), do not melt or drip when exposed to flames, and tend to self-extinguish due to their high nitrogen and water content. These properties make wool an ideal base material for insulation in residential and commercial buildings, where fire safety is a critical concern.

In another embodiment, wool's excellent thermal efficiency stems from its natural crimped structure, which traps air pockets. These pockets create an effective barrier to heat transfer, helping regulate indoor temperatures more effectively than many synthetic alternatives. Wool's ability to maintain thermal performance in both cold and hot conditions makes it versatile for year-round insulation. Unlike synthetic fibers, wool is not subject to degradation when exposed to UV light or temperature fluctuations, ensuring long-term stability and efficiency.

In another embodiment, by capitalizing on these properties, the proposed insulation material provides a solution that excels in both fire resistance and thermal efficiency, meeting high standards for modern construction and environmental sustainability.

In another embodiment, the addition of green fibers like hemp, soy, and banana fibers, though making up less than 50% of the composition, significantly enhances the mechanical properties of the insulation material. Each of these plant-based fibers has specific characteristics that improve the overall strength and durability of the material.

### Specification

The invention discloses a wool-based insulation material primarily composed of wool fibers, making up over 50% of the total composition, as illustrated in FIG. 1 (10). The wool is blended with a proprietary fire-retardant adhesive (20 in FIG. 1), which enhances fire resistance by binding the wool with a minority component of green fibers, comprising less than 50% of the total composition. These green fibers, shown as (30) in FIG. 1, include natural plant fibers such as hemp, soy, and banana fibers, which contribute to the insulation's sustainability, strength, and thermal performance. The material specifically excludes impurities, such as hemp hurd, wood chips, and stalk materials, ensuring a clean and high-quality blend. FIG. 2 (40) displays the finished insulation product, and FIG. 3 (50) shows the wool blend insulation pad in production. FIG. 4 (60) provides a process flow diagram of the manufacturing steps. The resulting nonwoven insulation material delivers excellent thermal efficiency, fire resistance, and environmental sustainability, suitable for various building applications where fire safety and eco-friendly materials are required.

### BRIEF DESCRIPTION OF DRAWINGS

FIG. 1 Exploded view of wool fiber (10), Proprietary adhesive fire retardant (20), hemp, soy or banana fiber (30)

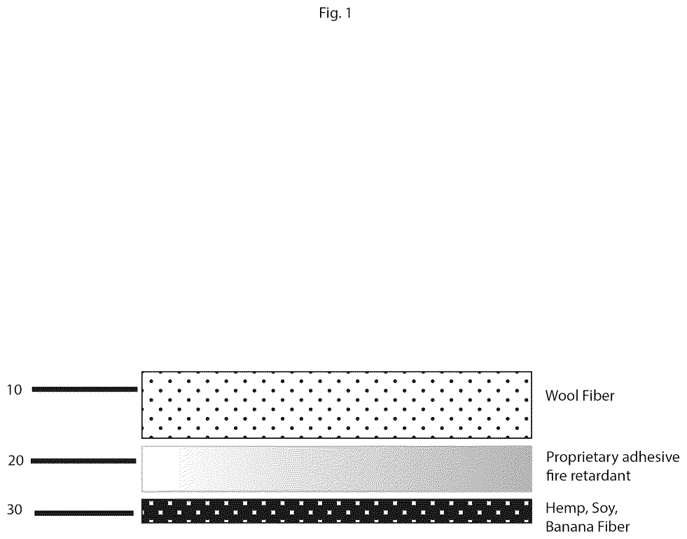

FIG. 2 Inclusive drawing of finished product (40)

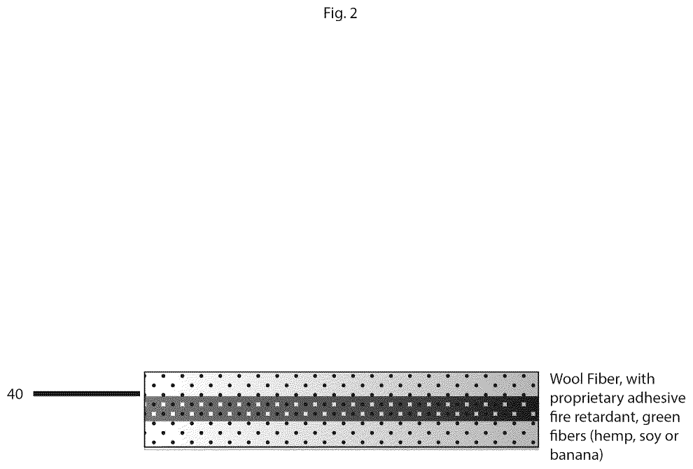

FIG. 3 Wool blend insulation pad in production (50)

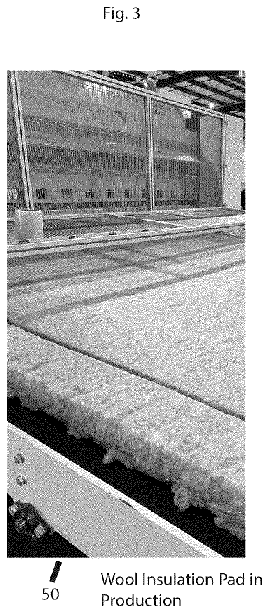

FIG. 4 Process (60)

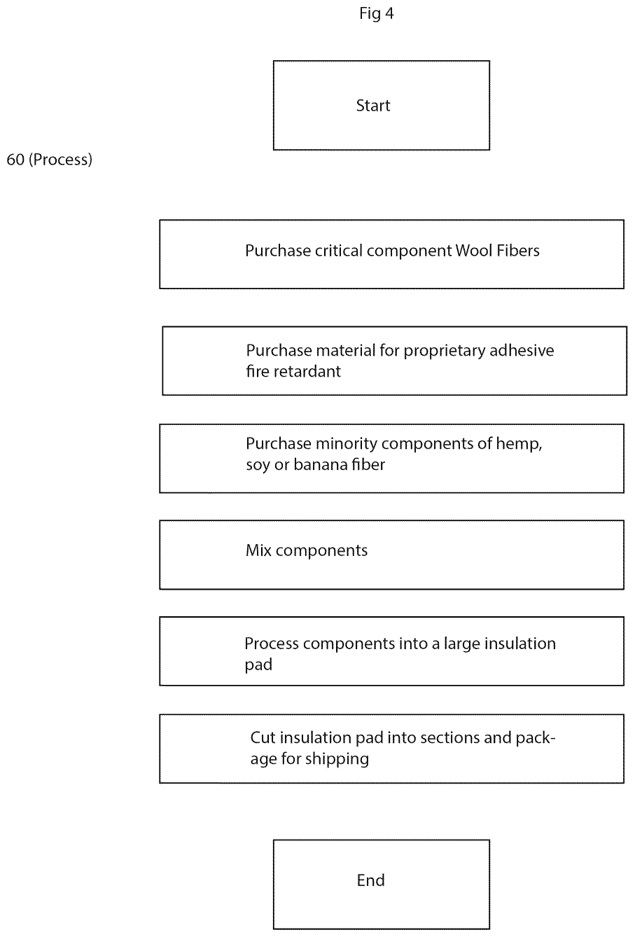

### FIELD OF THE INVENTION

The present application relates to wool-based insulation materials, specifically nonwoven blends that incorporate wool as the primary fiber component. These materials are designed for enhanced thermal efficiency, fire resistance, and environmental sustainability. Wool fibers are blended with other natural fibers and proprietary fire-retardant adhesives to produce a superior insulation material. These plant-based fibers contribute to the insulation's sustainability and structural properties. The blend specifically excludes impurities such as hemp hurd, wood chips, and stalk materials. This insulation material combines excellent fire resistance, thermal insulation, and environmental sustainability, with wool serving as the critical component.

### BACKGROUND OF THE INVENTION

Traditional insulation materials, such as fiberglass or cellulose, offer varying degrees of thermal efficiency but often come with environmental drawbacks, such as high energy consumption during production or limited biodegradability. Natural fibers, including wool, provide an eco-friendly alternative due to their renewability, biodegradability, and thermal efficiency properties. Wool is known for its natural fire resistance and thermal insulation properties, making it an excellent choice for eco-conscious insulation solutions.

Wool, when used as the majority fiber component in insulation, can offer better fire resistance and thermal efficiency compared to synthetic or plant-based materials. However, blending wool with other natural fibers like hemp, soy, or banana fibers can enhance the structural and mechanical properties of the insulation material while maintaining its sustainability.

Accordingly, a need exists for a wool-based insulation material that combines excellent thermal efficiency, fire resistance, and environmental sustainability by using wool as the critical component.

### SUMMARY OF THE INVENTION

The present invention discloses a wool-based insulation material, wherein the majority fiber component is wool, constituting more than 50% of the total composition. The wool is blended with a proprietary fire-retardant adhesive and a minority component of green fibers (less than 50%) derived from natural sources, such as hemp fibers, soy fibers, and banana fibers. These plant-based fibers contribute to the insulation's sustainability, mechanical strength, and thermal performance.

The blend specifically excludes impurities such as hemp hurd, wood chips, and stalk materials, ensuring a high-quality composition. The result is a nonwoven insulation material with superior fire resistance, excellent thermal efficiency, and reduced environmental impact, with wool serving as the essential component. The batt is designed to fit wall cavity dimensions of 15.5 inches or 23.5 inches in width, with lengths of 93 inches, and varying depths ranging from 3.5 to 11.5 inches to match standard wall construction.

### DETAILED DESCRIPTION OF THE INVENTION

### Description

### Field of the Invention

The present invention relates to an eco-friendly insulation material primarily composed of wool fibers, incorporating natural, plant-based fibers such as hemp, soy, and banana fibers in a secondary role. The insulation material is bound together with a proprietary adhesive fire retardant, making it suitable for use in a variety of building applications where both fire resistance and environmental sustainability are essential.

### Background of the Invention

Many conventional insulation materials rely on synthetic fibers and polymers, which are not environmentally friendly. There is a growing demand for sustainable alternatives that combine natural fibers with fire-resistant properties. Wool has long been recognized for its insulating properties, but previous inventions have not fully optimized the balance between fire resistance, sustainability, and fiber composition. This invention aims to provide an innovative solution by using wool as the majority component, combined with a proprietary adhesive fire retardant and a minority component of green fibers.

### Summary of the Invention

The insulation material described in this invention is primarily composed of wool fibers, which make up more than 50% of the total material. Wool provides excellent insulation due to its natural fire-resistant properties, moisture regulation, and thermal performance. A proprietary adhesive fire retardant (making up over 20% of the composition) binds the wool and green fibers together, enhancing the material's overall fire resistance. The remaining fiber content, less than 50%, consists of green, plant-based fibers, including but not limited to hemp fibers, soy fibers, and banana fibers. This unique combination of wool, adhesive fire retardant, and green fibers results in an eco-friendly insulation material that is both durable and fire-resistant, with the added benefit of using renewable resources. The invention specifically excludes impurities such as hemp hurd, wood chips, and stalk materials, ensuring a clean and high-performance product.

### Detailed Description of the Invention

The wool-based insulation blend of the invention comprises the following components: Wool Fibers (Over 50%): Wool is the primary component of the blend, selected for its natural insulating properties, flame resistance, and ability to regulate moisture. Wool fibers provide the bulk of the material's structure and contribute significantly to its thermal performance. Proprietary Adhesive Fire Retardant (Over 20%): A proprietary fire-retardant adhesive is used to bind the wool and green fibers together, offering enhanced fire resistance without compromising the environmental sustainability of the material. The adhesive is designed to be compatible with natural fibers and ensure the integrity of the blend.

Green Fibers (Less than 50%): The remainder of the material consists of green fibers, which enhance the sustainability and strength of the insulation. The green fibers used in the blend include: (Hemp Fibers: Selected for their strength and sustainability, hemp fibers contribute to the structural integrity of the insulation while maintaining an environmentally friendly profile. The fibers are processed to exclude hemp hurd, wood, and stalk materials, which are considered impurities. Banana Fibers: Known for their high tensile strength and biodegradability, banana fibers add strength and flexibility to the blend. Soy Fibers: Soy fibers offer flexibility and durability, further contributing to the performance of the insulation material.)

### Applications

The wool-based fiber insulation material is designed for use in various construction applications, particularly in walls, ceilings, attics, and other spaces where thermal insulation and fire resistance are required. The combination of wool and green fibers offers a sustainable alternative to traditional insulation materials, suitable for both residential and commercial buildings.

### DETAILED DESCRIPTION OF EMBODIMENTS

In a preferred embodiment, the insulation material comprises between 50% and 90% wool fibers, ensuring that wool is the predominant component. The wool provides natural thermal regulation, fire resistance, and moisture-wicking capabilities. The wool fibers are blended with less than 50% of plant-based fibers, such as hemp, soy, or banana fibers. These natural fibers contribute to the material's structural integrity and sustainability.

In another embodiment, the wool and plant fiber blend is combined with a proprietary fire-retardant adhesive that enhances the material's fire resistance without compromising its thermal properties. The fire-retardant adhesive ensures that the insulation meets or exceeds industry standards for fire safety in residential and commercial applications.

In another embodiment, the blend of wool and green fibers excludes impurities such as hemp hurd, wood chips, or other stalk materials to maintain the material's quality and effectiveness as an insulator. This results in a cleaner, more uniform material that performs well in various environmental conditions.

In another embodiment, the wool-based insulation material can be used in various applications, including but not limited to wall insulation, roof insulation, and acoustic panels. The wool component enhances thermal regulation in both hot and cold environments, while the plant fibers improve structural support.

In another embodiment, the insulation material's fire resistance makes it suitable for buildings with strict fire safety requirements, while its sustainability makes it an attractive option for eco-conscious consumers. Additionally, the insulation material is biodegradable, contributing to reduced environmental impact at the end of its life cycle.

The wool-based insulation material of claim 1, wherein the wool fibers have the ability to purify air by absorbing harmful pollutants such as formaldehyde, nitrogen oxide, and sulfur dioxide. The wool fibers trap and lock away these pollutants, contributing to improved indoor air quality, making the material particularly beneficial in environments with limited air exchange.

In another embodiment, the wool-based insulation material of claim 1, wherein the wool fibers contribute to enhanced thermal regulation through moisture absorption. As the wool fibers absorb moisture, an exothermic reaction releases heat, stabilizing the temperature within the insulated space. This moisture control improves the energy efficiency of buildings, reducing the demand on heating and cooling systems, while also creating a more comfortable living environment by managing humidity levels.

In another embodiment, the wool-based insulation material of claim 1, wherein the wool fibers exhibit superior moisture absorbency, capable of absorbing up to 30% of their weight in moisture without feeling wet. This unique hydrophilic property allows the insulation material to regulate indoor humidity levels effectively, preventing condensation, mold growth, and structural damage while maintaining a dry surface.

In another embodiment, wool is well-established as a highly efficient insulator due to its natural fiber structure, which traps air pockets, providing excellent thermal regulation. The decision to make wool the majority component (over 50%) ensures that the material takes full advantage of these natural properties. Wool's intrinsic moisture management also contributes to its superior insulating capacity, as it absorbs water vapor and releases it without compromising thermal efficiency.

In another embodiment, the inclusion of plant-based fibers such as hemp, soy, and banana (each less than 50%) provides structural support and sustainability benefits. These fibers are chosen for their compatibility with wool, as they have similarly beneficial environmental properties and can improve the tensile strength of the composite material without detracting from the thermal efficiency.

In another embodiment, the proprietary fire-retardant adhesive is necessary to enhance the fire resistance of the blend. While wool has natural flame-retardant properties due to its high nitrogen and moisture content, additional fire resistance is desirable for modern building standards. By incorporating a proprietary adhesive, the wool-based insulation achieves a higher level of fire safety while maintaining its structural integrity and thermal performance.

In another embodiment, the decision to exclude impurities like hemp hurd, wood chips, and stalk materials ensures a clean blend, minimizing any impact on thermal efficiency and consistency in performance. Impurities could introduce variability in fiber quality and performance, making the insulation less reliable.

In another embodiment, wool's natural fire resistance is one of its most important features in insulation applications. Wool fibers have a high ignition temperature (about 570-600° C.), do not melt or drip when exposed to flames, and tend to self-extinguish due to their high nitrogen and water content. These properties make wool an ideal base material for insulation in residential and commercial buildings, where fire safety is a critical concern.

In another embodiment, wool's excellent thermal efficiency stems from its natural crimped structure, which traps air pockets. These pockets create an effective barrier to heat transfer, helping regulate indoor temperatures more effectively than many synthetic alternatives. Wool's ability to maintain thermal performance in both cold and hot conditions makes it versatile for year-round insulation. Unlike synthetic fibers, wool is not subject to degradation when exposed to UV light or temperature fluctuations, ensuring long-term stability and efficiency.

In another embodiment, by capitalizing on these properties, the proposed insulation material provides a solution that excels in both fire resistance and thermal efficiency, meeting high standards for modern construction and environmental sustainability.

In another embodiment, the addition of green fibers like hemp, soy, and banana fibers, though making up less than 50% of the composition, significantly enhances the mechanical properties of the insulation material. Each of these plant-based fibers has specific characteristics that improve the overall strength and durability of the material.

1. A wool-based insulation material comprising of a majority fiber component of wool, constituting over 50% of the total composition, a minority component of green fibers, making up less than 50%, selected from natural fibers such as hemp fibers, soy fibers, and banana fibers, a proprietary fire-retardant adhesive blended with the wool and green fibers.

2. Pertaining to claim 1, the blend is excluding impurities such as hemp hurd, wood chips, and stalk materials.

3. The insulation material of claim 1, wherein the wool component provides natural fire resistance and thermal efficiency.

4. The insulation material of claim 1, wherein the green fibers contribute to the mechanical strength and sustainability of the insulation.

5. The insulation material of claim 1, wherein the proprietary fire-retardant adhesive enhances the fire resistance of the wool and green fiber blend.

6. The insulation material of claim 1, wherein the material is used for thermal insulation in buildings, providing enhanced thermal efficiency and fire safety.

7. The insulation material of claim 1, wherein the material is biodegradable, contributing to environmental sustainability.
